(19) United States
(12) Patent Application Publication
(10) Pub. No.: US 2025/0338213 A1
(43) Pub. Date: Oct. 30, 2025

(54) METHODS AND SYSTEMS FOR CONTROLLING POWER SAVE MODE IN WIRELESS LOCAL AREA NETWORK (WLAN)

(71) Applicant: SAMSUNG ELECTRONICS CO., LTD., Suwon-si (KR)

(72) Inventors: Manasi EKKUNDI, Bangalore (IN); Karthik Srinivasa GOPALAN, Bangalore (IN); Abhishek CHATURVEDI, Bangalore (IN)

(21) Appl. No.: 19/216,470

(22) Filed: May 22, 2025

Related U.S. Application Data
(63) Continuation of application No. PCT/KR2025/005345, filed on Apr. 21, 2025.

(30) Foreign Application Priority Data
Apr. 30, 2024 (IN) 202441034415
May 10, 2024 (IN) 202441036939
Mar. 11, 2025 (IN) 202441034415

(51) Int. Cl. H04W 52/02

(52) U.S. Cl. CPC H04W 52/0229

(57) ABSTRACT

Embodiments herein disclose methods and systems for controlling a power saving in a Wireless Local Area Network (WLAN). These embodiments include determining, by a station (STA), a need to indicate a power save mode including at least one of enablement or update of a status of the STA and a user input. These embodiments include transmitting, an updated power save mode information that includes associated configurable parameters impacting power save to peer STA based on determination. Embodiments also involve determining a default power save mode for station, upon the STA powering up. The method includes transmitting default power save mode information and at least one configurable operating mode capability to peer STA, based on default power saving mode. Controlling power saving based on default power save mode information.

### CROSS REFERENCE TO RELATED APPLICATIONS

This application is a continuation application of International Application No. PCT/KR2025/005345, filed on Apr. 21, 2025, in the Korean Intellectual Property Office and claiming priority to, and deriving the benefit of, Indian Provisional Application 20/244,1034415 filed on Apr. 30, 2024, Indian Provisional Application 20/244,1036939 filed on May 10, 2024, and Indian Complete patent application No. 202441034415 filed on Mar. 11, 2025, the contents of which are incorporated herein by reference, in their entireties.

### TECHNICAL FIELD

This disclosure relates to power saving methods and systems, and more particularly to power saving methods and systems for controlling power save mode management of a station (STA) in a Wireless Local Area Network (WLAN).

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. Since many devices are portable, power-saving features get more and more important. The Institute of Electrical and Electronics Engineers (IEEE) 802.11 standards define many power-saving features, in the Task Group bn (Tgbn) for Ultra High Reliability (UHR) specifications, involving multiple power-saving features, such as Dynamic Power Save, Scheduled Power Save and Cross-link Power Save.

The description set forth in the background section should not be assumed to be prior art merely because it is set forth in the background section. The background section may describe aspects or embodiments of the present disclosure.

### SUMMARY

The disclosure provides methods and systems for defining a framework of operations for controlling power save mode in a Wireless Local Area Network (WLAN), wherein different power saving modes are enabled for different types of devices based on different KPIs. The framework includes a method of indicating the default power save mode, and a method of updating or changing the power save mode.

The disclosure also provides methods and systems for providing configurability of parameters during power save mode enablement or update and these parameters can be included in messages such as, but not limited to, beacon, (re) association request/response, probe request/response, management frames, action frames, control frames etc.

The disclosure also provides methods and systems for defining and managing power save categories.

The disclosure also provides methods and systems for defining one or more power save categories, wherein the definition includes different power save profiles that map the associated bandwidth, Spatial streams, MCS, number of links etc.

The disclosure also provides at least one power save category in capabilities, power save category for mode change, power save category for cross link power save features.

One aspect of the present disclosure provides a station (STA) in a wireless network. The STA comprises at least one processor including processing circuitry and memory storing instructions. The instructions, when executed by the at least one processor individually or collectively, cause the STA to determine a need to inform a first device of update of a power save mode of the STA based on at least one of a status of the STA or a user input. The instructions, when executed by the at least one processor individually or collectively, further cause the STA to transmit information on an updated power save mode to a first device. The information includes at least one configurable parameter associated with the power save mode. The first device may be a station (STA) or an access point (AP).

In some examples, the information on the updated power save mode is transmitted to the first device irrespective of data activity.

In some examples, the instructions, when executed by the at least one processor individually or collectively, further cause the STA to determine a default power save mode for the STA, when the STA powers up. The instructions, when executed by the at least one processor individually or collectively, further cause the STA to transmit information on a default power save mode and at least one configurable operating mode capability to the first device, based on the default power save mode. The instructions, when executed by the at least one processor individually or collectively, further cause the STA to control power saving based on the default power save mode.

In some examples, the information on the updated power save mode information is transmitted to the first device based on at least one frame format. The at least one frame format comprising at least one of: a management frame format, an action frame format, a control frame format, or a beacon frame format to indicate at least one enablement or update of operational parameters for the associated power save mode and feature.

In some examples, the at least one frame format indicates a power saving feature or the power save mode

In some examples, the at least one frame format indicates at least one of a power saving feature, a power save mode, operational parameters: bandwidth (BW), a number of spatial streams (NSS), a modulation and coding scheme (MCS), or link information for at least one enablement or update of power save mode.

In some examples, the instructions, when executed by the at least one processor individually or collectively, further cause the STA to transmit the information on the default power save mode via at least one of: a beacon frame, a re-association request frame, a re-association response frame, a probe request frame or a probe response frame.

In some examples, the default power save mode information comprises at least one of: a type of power save mode, a power save mode feature, operational parameters, bandwidth (BW), a number of spatial streams (NSS), a modulation and coding scheme (MCS), or a link information.

In some examples, the instructions, when executed by the at least one processor individually or collectively, further cause the STA to transmit an indication of a power saving category to the first device.

In some examples, the transmitting of the indication of the power saving category comprises configuring a power saving category included in different power save features and different power save modes. In some examples, the transmitting of the indication of the power saving category comprises transmitting an indication of a default power save category based on determining the default power save mode of operation. In some examples, the transmitting of the indication of the power saving category comprises determining a need to transmit the power saving category to the first device when at least one of: the STA powers up or the power saving category changes. In some examples, the transmitting of the indication of the power saving category comprises transmitting the modified power saving category to the first device.

In some examples, a mapping table is utilized for at least one of: at least one single-link operation or at least one multi-link operation in the power saving category.

In some examples, the power saving category is indicated using a frame structure, wherein the power saving category includes at least one of a bandwidth (BW), a number of spatial streams (NSS), a modulation and coding scheme (MCS), or link information.

In some examples, the frame structure indicates the power saving category associated with at least one of a power saving feature or a power save mode of an operation.

In some examples, the default power save category is indicated in a capability information element of the STA.

In some examples, the power saving category is associated with a power saving feature and a mode of an operation is indicated in a power saving capability information element of the STA.

In some examples, the instructions, when executed by the at least one processor individually or collectively, further cause the STA to determine whether a dynamic power save mode is supported. In some examples, the instructions, when executed by the at least one processor individually or collectively, further cause the STA to set a power saving category associated with a low power and high-power mode in response to determining that the dynamic power save mode is supported.

In some examples, the instructions, when executed by the at least one processor individually or collectively, further cause the STA to determine whether a scheduled power save mode is supported. In some examples, the instructions, when executed by the at least one processor individually or collectively, further cause the STA to set the power saving category to be associated with at least one of: a low capability mode or a high capability mode in response to determining that the scheduled power save mode is supported.

In some examples, the instructions, when executed by the at least one processor individually or collectively, further cause the STA to determine whether a cross-link power management mode is supported. In some examples, the instructions, when executed by the at least one processor individually or collectively, further cause the STA to set a power saving category associated with each link in response to determining that the cross-link power management mode is supported.

In some examples, the instructions, when executed by the at least one processor individually or collectively, further cause the STA to determine whether the first device remains in at least one of a high capability mode or a low capability mode. In some examples, the instructions, when executed by the at least one processor individually or collectively, further cause the STA to transmit an indication in an Initial Control Frame (ICF) to indicate to the first device that upon receiving a notification, the first station shall remain in at least one of the high capability mode or the low capability mode.

One aspect of the present disclosure provides a computer-implemented method for wireless communication by a station (STA) in a wireless network. The method comprises determining, by a station (STA), a need to indicate a power save mode including at least one of enablement or update based on at least one of a status of the STA or a user input. The method comprises transmitting, by the STA, an updated power save mode information that includes at least one associated configurable parameter associated with power save to a first station based on the determination.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF THE DRAWINGS

FIG. 1A is an example diagram illustrating different KPIs that are estimated to be required for different types of devices.

FIG. 1B is an example diagram illustrating different types of devices that cater to different use cases, which need to meet different set of KPIs and hence their associated power consumption profiles.

FIG. 1C illustrates an example scenario, wherein an ICF (Initial Control Frame) sequence can be used to change the power save modes in a Dynamic Power Save Feature.

FIG. 2A is an example block diagram illustrating various components of a station to interact with an Access Point (AP), for controlling the power saving in a Wireless Local Area Network (WLAN), according to an embodiment.

FIG. 2B illustrates the information in the frame body of Management Frames to indicate default or current power save mode, according to an embodiment.

FIG. 2C illustrates the Element ID information for the newly defined Element for indicating Default power save mode, according to an embodiment.

FIG. 3A and FIG. 3B illustrate the elements in the frame body to indicate default or current power save mode, according to an embodiment.

FIGS. 3C, 3D and 3E illustrate power save features and power save mode to enable or update using control or action frames along with the configurable associated parameters, according to an embodiment.

FIGS. 4A, 4B and 4C illustrate example scenarios, wherein default power save mode is indicated and enabled which saves unnecessary ICF-ICR exchanges during DPS mode, according to an embodiment.

FIGS. 5A and 5B illustrate example scenarios, wherein using management/action frames, an AP indicates to peer STA about preferred mode of operation there by providing flexibility of operation during DPS mode without the need of an ICF-ICR sequence before every data exchange, according to an embodiment.

FIG. 6 illustrate example scenario, wherein the power save mode save indication is performed based on STA1 and STA 2 associated with AP where STA2 indicates a change in power save mode of operation through an Action frame to indicate its preferred mode of operation, according to an embodiment.

FIGS. 7A and 7B illustrate a frame format for indicating the power save feature and its associated category, according to an embodiment.

FIG. 8 is an example flow diagram illustrating that the power save category of the STA, according to an embodiment.

FIG. 9 illustrates the frame format for power save mode indication in cross link power save, according to an embodiment.

FIG. 10 illustrates the frame format to indicate the power save mode, according to an embodiment.

FIGS. 11A and 11B are example sequence diagrams illustrating the usage of power save categories in capabilities, according to an embodiment.

FIGS. 12A, 12B and 12C are example sequence diagrams illustrating the power save mode change, according to an embodiment.

FIG. 13 illustrates an action frame associated with the category and action field, according to an embodiment.

FIG. 14 is an example diagram illustrating the frame format defined as a management frame with associated element ID/extension ID, according to an embodiment.

FIG. 15 depicts the frame format for power save mode indication in cross link power save, according to an embodiment.

FIG. 16 and FIG. 17 are flow charts illustrating a method for controlling power saving in the WLAN, according to an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding aspects of an embodiment. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The disclosure provides methods and systems for controlling power save in a Wireless Local Area Network (WLAN) by determining and indicating configurable parameters associated with a default power save mode of a station (STA) after powering up. Further the disclosure relates to updating the configurable parameters associated with a power save mode of the STA based on the status of the STA and a user input. Further the disclosure relates to indicating power save category as for notifying the capabilities associated with the power save mode(s) of operation and further based on determining a need to transmit the associated default power save category to the peer STA like an access point (AP) when at least one of the STA powers up or the power save category changes.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Currently, the Institute of Electrical and Electronics Engineers (IEEE) 802.11 standards define many power-saving features, in the Task Group bn (Tgbn) for Ultra High Reliability (UHR) specifications, involving multiple power-saving features, such as Dynamic Power Save, Scheduled Power Save and Cross-link Power Save.

The Dynamic Power Save (DPS) feature refers to a situation where a station (STA) that acts as a UHR Mobile Access Point (AP) or a UHR non-AP STA, where the STA can transition from a lower capability mode to a higher capability mode upon the reception of an initial control frame. The lower capability mode may include features such as 20 MHz bandwidth, one spatial stream (SS), limited data rates, and a specific Physical Protocol Data Unit (PPDU) format. In contrast, the higher capability mode may involve operating bandwidth, number of spatial streams (NSS), and modulation and coding schemes (MCS) that offer at least one higher capability than the lower power capability mode.

The Scheduled Power Save feature allows the STA to optionally indicate or update a periodic unavailability period to its peer station. The STA can operate in different modes, including a doze mode (for example), where during the doze mode, the STA may have no reception (RX) of the signal or a limited transmission/reception (TX/RX) of the signal, in a low capability mode. Alternatively, the STA can periodically switch to an active mode, operating at a higher capability.

There are many devices, including stations (STAs) and Access Points (APs), and various use cases that adhere to the 802.11 standards. The different device types include multi-link devices MLD (i.e., a single device operating over multiple wireless links simultaneously, such as smartphones, tablets, laptops, and so on) in both STA and AP configurations, Internet of Things (IoT) devices, extended reality (XR) devices, peer-to-peer (P2P) capable devices, video devices, and gaming devices. Different kind of devices require different types of key performance indicators (KPIs) that include throughput, efficiency, latency, reliability and power consumption among many others.

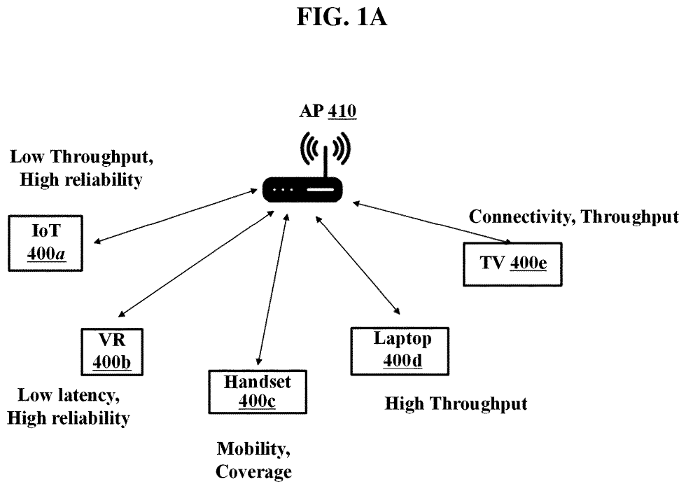

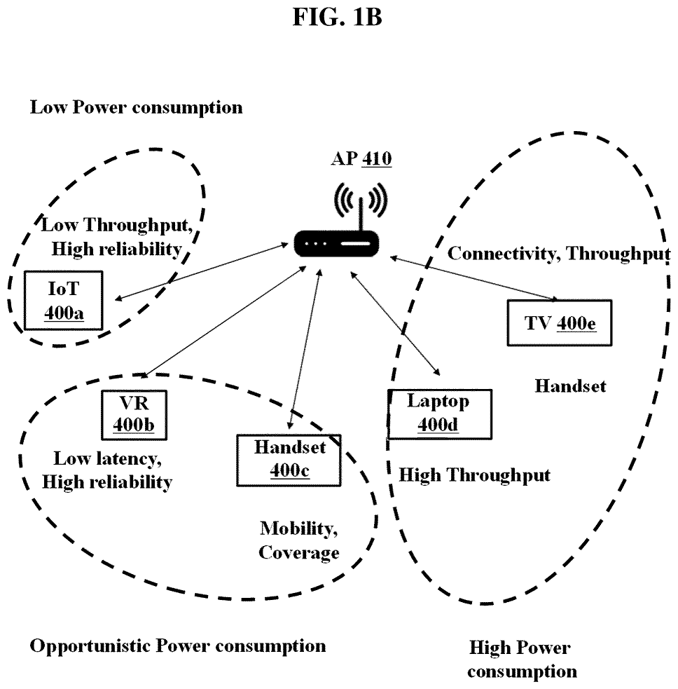

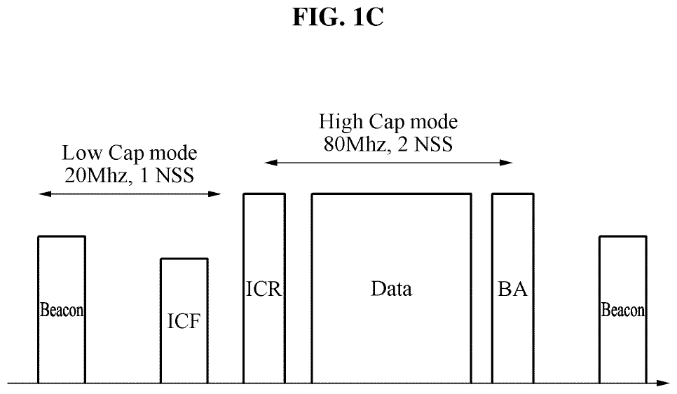

A typical home (as shown in FIG. 1A) can host IEEE 802.11 powered home appliances like TV, Refrigerator, light bulbs, smart appliances and at the same time each member of the house can own a plethora of handsets, wearables, XR devices, tablets and laptops. Additionally, it is also possible that the homes are embedded with smart sensors (IT) that connect over the IEEE 802.11 network. Similarly, there are denser environments like airports, offices, malls etc that have multiple users to cater to and also industries require connectivity over 802.11 networks for a wide set of requirements.

As is evident from the current ecosystem in the home and outdoor spaces, a wide variety of devices exist. Each of the devices have different performance requirements. Sensor based IoT devices may only require low latency, and high reliability network. User specific devices like laptops, TV may require high throughput for certain applications like streaming, data upload/download, and so on. XR devices might require high throughput, reliability, latency and mobility. Mobile handsets would require high coverage and mobility and so on.

To control multiple types of traffic and associated priorities, the current 802.11 standard already defines certain traffic and access categories.

FIG. 1A is an example diagram illustrating the different KPIs that are estimated to be required for different types of devices. As illustrated, an AP 410 is connected with an IoT device 400a, a Virtual Reality (VR) device 400b, a handset 400c, a laptop 400d, and a television 400e. an IoT device 400a may require low throughput and high reliability, a Virtual Reality (VR) device 400b may require low latency and high reliability, a handset 400c, a laptop 400d may require high throughput, and a television 400e may require connectivity and throughput. Different use cases and device categories are associated with different traffic priority and requirements. Different categories are controlled via traffic and access categories to schedule data sessions and access to a medium. However, the devices also are associated with different power consumption requirements. For example, an IoT sensor may need to have very long battery life, similarly wearables need to have more efficient power consumption requirements compared to wall powered devices like TV 400e and refrigerators. Currently, there are multiple power save mechanisms and in Tgbn, there is flexibility to define different power save modes (low and high capability or active and doze modes) with Bandwidth (BW), number of links, number of antennas, etc. Hence there is a need to clearly categorize the power save requirements for different devices and provide a unified framework for operations. FIG. 1B shows an example scenario where different devices are associated with different power consumption profiles.

As depicted in FIG. 1B. For example, a device such as a laptop 400d requires a high throughput, but need not operate by default in a low power mode as it can be wall powered. On the other hand, devices that need to save power, like IoT devices 400a, can operate by default in a low power mode and transition to other power save modes only as needed. Modern handsets have power save modes enabled for the user. Based on that, a handset can choose its default mode of operation, which can be termed as opportunistic power consumption. Therefore, a flexible framework needs to be defined in Tgbn to enable different default operating modes for different types of devices based on their use cases and associated KPIs. Alternatively, when a power save feature is enabled a framework can be defined to operate or update the device in the required mode.

The power save features in the Tgbn group include multiple modes of operation with different capabilities, such as doze mode, low capability mode, and high capability mode. Currently, using an Initial Control Frame (ICF), the ICF will enable the transition from the low capability mode to a high capability mode for the stations and the mobile APs in dynamic power save mode. The messages related to the mode changes can be transmitted from the STA to the AP, and vice-versa. Further, there can be various periods where the STA or AP needs to inform each other about mode changes for power saving, even without requiring a transmission. The information or parameters that need to be included in the message transmission for the mode changes wherein the parameters can be included in various types of messages, such as Beacon frames, (re) association requests/responses, probe requests/responses, action frames, control frames, and so on.

FIG. 1C depicts an example scenario, wherein an ICF (Initial Control Frame) sequence is used to change the power save modes of the devices. The UHR specifications task group Tgbn suggest that an Initial Control Frame (ICF) sequence can be used to change power save modes. However, in certain situations, flexibility will be required to determine the power save mode outside of the Transmission Opportunity (TXOP) and without needing an ICF, based on the current requirements of the device.

Enhanced Distributed Channel Access (EDCA) mechanism is defined in 802.11 to provide different and distributed access to the wireless medium using 8 different user priorities. Further, EDCA improves the wireless channel access by assigning different priorities and parameters to packets with different priorities.

TABLE 1

| | UP (Same | | | Transmit queue | | |
|---|---|---|---|---|---|---|
| | as IEEE | | | (dot11Alternate- | | |
| | 802.1D | IEEE | | EDCAActivated | Transmit queue | |
| | user | 802.1D | | false or not | (dot11.Alternate | |
| Priority | priority) | designation | AC | present) | EDC.AActivated) | Designation |
| Lowest | 1 | BK | AC_BK | BK | BK | Background |
| Highest | 2 | — | AC_BK | BK | BK | Background |
| | 0 | BE | AC_BE | BE | BE | Best Effort |
| | 3 | EE | AC_BE | BE | BE | Best Effort |
| | 4 | CL | AC_VI | VI | A_VI | Video |
| | | | | | | (alternate) |
| | 5 | VI | AC_VI | VI | VI | Video |
| | | | | | | (primary) |
| | 6 | VO | AC_VO | VO | VO | Voice |
| | | | | | | (primary) |
| | 7 | NC | AC_VO | VO | A_VO | Voice |
| | | | | | | (alternate) |

NOTE
The Designation column is an indication of general usage and guidance. Actual uses of each UP are implementation specific.

As shown above in Table 1, there are different priorities associated to different types of traffic and a device is categorized into access categories. The access categories aid the EDCA to provide different backoff and other parameters required to access the medium as per traffic priority. In legacy specifications as shown in Table 1, there are access categories for managing different types of traffic categories which makes the exchange of information via categories easy to communicate. However, there are no power save categories defined to identify the different levels of power save mode and user devices.

Usually, the power save feature is exchanged in the capabilities via multiple messages like Beacon, Probe Request/Response, (re) Association request/response, etc. Since there are multiple types of devices and each device can have different implementation limited in hardware and designed as per need, each of these devices need to indicate an entire profile of operations in the low power mode and the high-power mode. The method of indicating the entire profile may cost high in terms of message size (for example). Hence there is a need to define a common framework using which the power save feature, its capabilities and profile associated with mode can be indicated.

Power save category for power save mode change: the devices can have flexibility to operate in any power save mode. Each power save mode itself can be operated in different profiles based on the need of traffic and performance at the moment. Hence, a power save mode change indication can be sent to update the AP and STA about the change of power save mode preference. During this exchange, sending across the entire profile would end up increasing the size of the message and hence introducing an optimized and uniform framework for exchanging the power save feature, mode and its associated profile is necessary.

Power save category for cross link, in the MLD, a single link can indicate the power save mode of the other links. Single link refers to one of the multiple wireless links or connections that the MLD can establish and operate on. The additional/other links may be wireless links established by the MLD, aside from the single link currently being referenced or used. For example, if an MLD is operating on a 5 GHz link and also maintains a 2.4 GHz link, the 2.4 GHz link would be one of the other links. However, each link can be configured or designed to support different BW, NSS, MCS etc. Hence, the primary link is burdened to inform all these parameters of other links as well. The primary link is the central or main link used by the MLD to manage communication with the Access Point (AP) or other devices. Hence there is a mechanism to inform the associated power save profile parameters of each link even when the primary link is indicating for other links.

an embodiment an embodiment an embodiment an embodiment an embodiment an embodiment an embodiment an embodiment an embodiment an embodiment an embodiment an embodiment an embodiment an embodiment an embodiment an embodiment an embodiment an embodiment

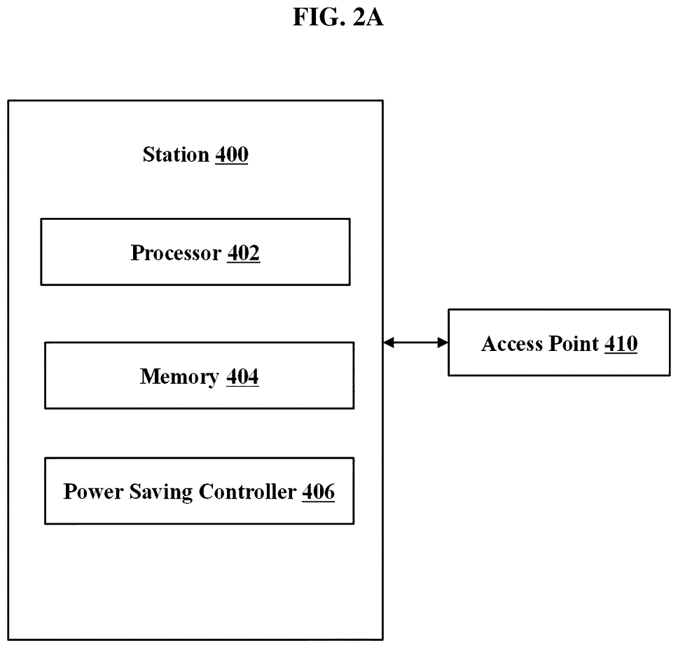

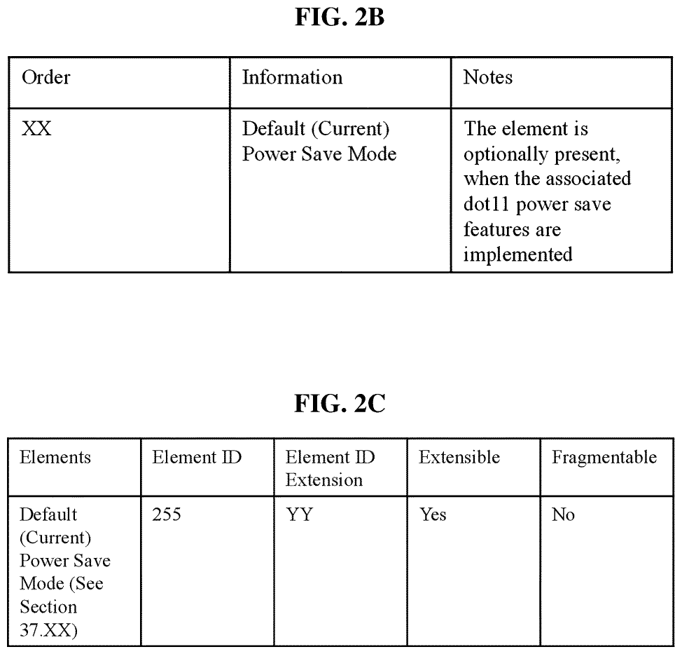

an embodiment Referring now to the drawings, and more particularly to FIGS. 2 through 17, where similar reference characters denote corresponding features consistently throughout the figures, there are shown at least one embodiment.

FIG. 2A is an example block diagram illustrating various components of a station to interact with an Access Point (AP), for controlling the power saving in a Wireless Local Area Network (WLAN). As illustrated in FIG. 2A, the station 400 comprises a processor 402, a memory 404, and a power saving controller 406. The processor 402 includes processing circuitry. The block diagram is also applicable for the components within a Mobile-AP, and the Mobile-AP comprises a processor 402, a memory 404, and a power saving controller 406 while interacting with a peer STA.

The station (STA) 400 referred to herein may be an electronic device/user device that is used by the user to connect, interact, and/or control the operations of the plurality of other devices using a 3GPP network. Examples of the STA 400 may include, but are not limited to, a smartphone, a mobile phone, a video phone, a computer, a tablet personal computer (PC), a laptop, a wearable device, a personal digital assistant (PDA), an IoT device, or any other device that may use a 3GPP network. A STA can also be a Mobile-AP that has enabled the power save features like dynamic, scheduled or cross link power save.

The processor 402 or the processing circuitry of the processor 402 may include one or a plurality of processors. The one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The memory 404 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The power saving controller 406 may be configured to determine a default power save mode for the station after powering up. The power saving controller 406 may transmit the default power save mode information to an access point (AP) or peer station 410. The power saving controller 406 can control the power saving based on the default power save mode information. The controller can determine the need to change the power save mode based on at least one of a status of the STA 400 or a user input. The power saving controller 406 can transmit an updated power save mode information to the AP 410 based on the determination. In the case of a Mobile-AP the power saving controller 406 can determine a need to change the power save mode based on the status of the STA that is a mobile-AP. The power saving controller 406 can transmit an updated power save mode information to the STA based on the determination.

Some examples as disclosed herein, the current or default power save mode and its associated parameters if present can be described as Elements which are sent in Management frames like Beacon, (Re-)Association Request/Response, Probe Request/Response etc. FIG. 2B shows the information in the frame body of Management Frames to indicate default or current power save mode. Default power save mode indication in a UHR STA (both mobile-AP and non-AP STA) is designed to send a default power save mode indication. Alternatively, a non-mobile or mobile AP can also use the default mode power save indication as a means to indicate its current power save mode.

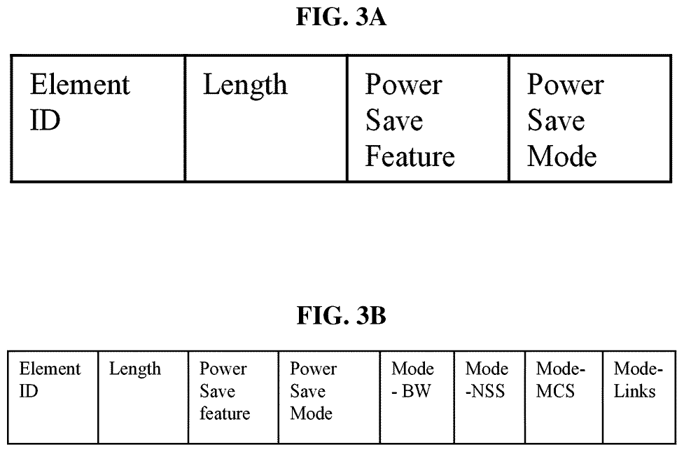

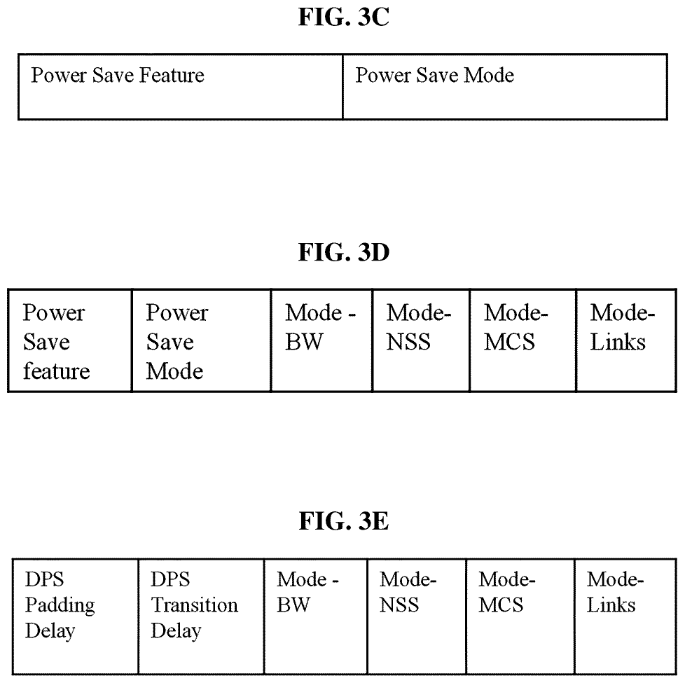

FIG. 2C shows the Element ID information for the newly defined Element for indicating Default power save mode. In some examples, the default or current power save mode and its associated parameters can be included in a frame format as per FIG. 3A or FIG. 3B where each field is optionally present where the element ID is used to indicate the associated default or current power save feature, its mode and parameters. Power save feature can be optionally present when multiple power save features are required to indicate the usage or it can be used to represent Dynamic Power Save Feature specifically without explicitly indicating the same.

Under Section 1 in default or current power save mode indication using elements, the frame format for default power save mode indication is as shown in FIG. 2B and FIG. 2C shows the elements in the frame body to indicate default or current power save mode. This frame body can be included in Beacon, (re) association request/response, probe request/response or any other new message in UHR. The default power save mode indication is categorized to have multiple aspects such as feature and mode. The feature serves as the indication, which can include whether the power save feature is turned ON or OFF currently. The mode shall indicate the current default power save mode when the associated power save feature is turned ON. For an AP the default power save mode indication can alternatively be associated to the current power save mode indication.

Further, the embodiments herein disclose determining that a dynamic power save mode is supported; and setting a default power save mode associated with a low power and high-power mode; updating the power save mode for either low or high power in response to determining that the dynamic power save mode is supported.

Further, the embodiments disclosed herein determine that a scheduled power save mode is supported and setting the default power save mode associated with at least one of a low or doze mode or an active mode in response to determining that the scheduled power save mode is supported.

Further, the embodiments herein disclose determining that a cross-link power management mode is supported and setting a default power save mode associated with each link in response to determining that the cross-link power management mode is supported.

Further, the embodiments herein disclose determining that a dynamic power save mode is supported; and setting a change in power save mode associated with a low power and high-power mode; updating the power save mode parameters for either low or high-power capabilities in response to determining that the change in dynamic power save mode operation is determined.

Further, the embodiments disclosed herein determine that a scheduled power save mode is supported and setting the change in power save mode associated with at least one of a low or doze mode or an active mode; updating the power save mode parameters for either doze or active mode in response to determining that the change in scheduled power save mode operation is determined.

Further, the embodiments herein disclose determining that a cross-link power management mode is supported and setting a change in power save mode associated with each link in response to determining that the cross-link power management mode is supported and a change in power save mode parameters associated with the link is determined.

FIG. 3A indicates the elements in the frame body to indicate default or current power save mode. In an embodiment herein, the mode can include only the associated mode of operation. The remaining aspects shall be determined by the capabilities of the STA as shown in FIG. 3A. Table 2A indicates the elements in the frame body to indicate default or current power save mode. This frame body can be included in Beacon, (re) association request/response, probe request/response.

TABLE 2A

| Field | Definition | Encoding in bits |
|---|---|---|
| Power Save | This field indicates the type of | 00 - Power save features OFF |
| Feature | power save feature | 01- Dynamic Power save feature is |
| (Optional) | | ON and others are OFF |
| | | 10 - Scheduled power save feature is |
| | | ON and others are OFF |
| | | * Can be extensible in the future |
| Power Save | This field indicates whether the | 01 - Low capability mode (if |
| Mode | feature is ON or OFF and if its ON | Dynamic Power save) |
| | then what is the mode its operating | 01 - Doze mode (if Scheduled Power |
| | mode | save) |
| | | 10 - High Capability mode (if |
| | | Dynamic Power save |
| | | 11 - Active mode (if Scheduled |
| | | Power save) |

In an embodiment herein, the mode can alternatively include the associated parameters like Bandwidth (BW), link, Number of Spatial Streams (NSS), Modulation and Coding Scheme (MCS) and other parameters that indicate how it shall operate in each mode as shown in FIG. 3B. FIG. 3B indicates the elements in the frame body to indicate default or current power save mode. Table 2B indicates the elements in the frame body to indicate default or current power save mode.

TABLE 2B

| Field | Definition | Encoding in bits |
|---|---|---|
| Power Save | This field indicates the | 0- Dynamic Power save feature |
| Feature | type of power save | 1 - Scheduled power save feature |
| (Optional) | feature | * Can be extensible |
| Power Save | This field indicates | 01 - Low capability mode (if Dynamic Power |
| Mode | whether the feature is ON | save) |
| | or OFF and if its ON then | 01 - Doze mode (if Scheduled Power save) |
| | what is the mode its | 10 - High Capability mode (if Dynamic Power |
| | operating mode | save |
| | | 11 - Active mode (if Scheduled Power save) |
| Mode - BW | This defines the | This can be encoded as a 3-bit information |
| | maximum bandwidth the | 000 - Indicates change in bandwidth is not |
| | device can support in | supported. |
| | current mode of operation | 100- BW change is supported. Only 20 MHz |
| | | 101 - BW change is supported. Up to 40 MHz |
| | | 110 - BW change is supported. Up to 80 MHz |
| | | 111 - BW change is supported. Up to 160 MHz |
| Mode- NSS | This defines the | This can be encoded as a 2-bit information |
| | maximum Spatial streams | 00- Indicates changing NSS is not supported in |
| | the device can support in | low cap mode |
| | current mode of operation | 10- Indicates changing NSS is supported. Up to 1 |
| | | NSS |
| | | 11 - Indicates changing NSS is supported up to 2 |
| | | NSS |
| Mode- MCS | This defines the | It can be indicated using 5 bits |
| | maximum MCS that can | 00000 - Changing MCS in low cap mode is not |
| | be supported in current | supported |
| | mode of operation | 10000 - Changing MCS is supported. Up to |
| | | BPSK. |
| | | 11111 - Changing MCS is supported. Up to MCS |
| | | 15. |
| Mode - | This defines the number | It can be indicated using 2 bits |
| Links | of links that can be | 00- 1 link |
| | supported in the current | 01 - 2 links |
| | mode of operation | 10- 3 links |
| | | Extensible in future |

The default power save mode indication can be sent in Beacon, (Re) Association Request/Response, Probe Request/Response or any other new message in UHR. For an AP, the default power save mode indication can alternatively be associated to the current power save mode indication.

Under section 2 in power save mode enablement/update using control or action frame, the method to enable/indicate/update power save mode and its configurable associated parameters can be through control frames or action frames. The frame format is as shown in FIG. 3C or FIG. 3D. The frame format can be included in an action frame like a UHR Operating Mode Notification or any other new message that is defined to indicate power save mode enablement or update like DPS Operation Parameters. Similarly, such a frame format can also be indicated in a UHR control frame which can be an A-control frame or new control frame format. The scope of defining these frames follows baseline rules. FIG. 3C field is described as in Table 2A and FIG. 3D is described as in Table 2B. An example Protected Action Frame Format for UHR Operating Mode Notification is shown in Table 2C that includes the frame format including power save mode and its associated parameters.

TABLE 2C

| Order | Meaning |
|---|---|
| 1 | Category |
| 2 | Protected UHR Action |
| 3 | Dialog Token |
| 4 | Option 1: Section 1 for including Power Save Feature and |
| | mode as Elements as in FIG. 3A or 3B |
| | Option 2: Section 2: for including Power Save mode |
| | enablement/update of parameters as in FIG. 3C/3D/3E |

Another example use case where the aspects of the current embodiment can be used is in the Dynamic Power Save (DPS) to include the configurable Bandwidth, NSS in DPS operation parameters. DPS operation parameters can be sent in UHR capabilities as part of management frames like Beacon, Association Request/Response or Probe Request/Response. DPS operation parameters can also be included in UHR Control or UHR action frames. FIG. 3E shows an example of how the DPS operation parameters can include fields as per FIG. 3D and Table 2B.

During initial association procedure, DPS operating parameters can indicate BW, NSS, MCS etc., as preferred low capability mode of operations. Power Save Mode and feature indication is an optional field as specifically the current scenario is for DPS. If present, Power save mode can indicate low or high as defined in Table 2A/Table 2B, and when not present it is understood to represent low capability mode parameters. For High capabilities, device can use own operating mode or device capabilities.

Some examples herein discloses, the STA 400 may determine a default power save mode upon the STA powering up. The STA may transmit the default power save mode information to the AP 410 based on the default power save mode. The STA can control the power save based on the default power save mode information, comprising at least one frame format, wherein the at least one frame format comprises at least one of a management frame format, an action frame format, a control frame format, or a beacon frame format. The at least one frame format indicates a power save feature and the power save mode. The at least one frame format indicates a power saving feature, a power save mode along with at least one of: bandwidth (BW), a number of spatial streams (NSS), a modulation and coding scheme (MCS), or link information. The at least one frame format which includes one of Bandwidth (BW), Number of spatial streams (NSS), MCS, link information for a power save feature enablement or update. An indication of the default power save mode is sent via at least one of: a Beacon, a Re-association request, a Re-association Response, a probe request or a probe response. The power save mode information comprises at least one of: a type of power saving mode, and a power save mode feature, Associated parameters like BW, NSS etc.

The STA can determine the need to change or update the power save mode based on at least one of a status of the STA or a user input. The STA can transmit an updated power save mode information to the AP or peer STA based on the determination. The STA transmits the updated power save mode information to the AP or peer STA in an unsolicited manner irrespective of data activity. An AP also can transmit its updated power save mode based on status of AP to STA. The power save mode information comprises at least one of: a type of power saving mode, or a power save mode feature, Associated parameters like BW, NSS etc. An indication of the enablement/update or change of power save mode can be sent via an Action Frame, Control Frame, Management Frame or any new frame. The contents of the frame format are disclosed in the present invention.

The STA can indicate a power save category to the AP, wherein the STA configures a first power save category different from a default power save category of a plurality of power saving categories. The STA can determine a need to transmit the power save category to the AP when at least one of the STA powers up, or the power save category changes. The STA transmits the first power save category to the AP. Mapping table is utilized for at least one of: at least one single-link operation, or at least one multi-link operation in the power save category. Further, the power save category is indicated using a frame structure, wherein the power save category is defined to include a bandwidth (BW), number of spatial streams (NSS), modulation and coding scheme (MCS), and link information. A frame structure is defined to indicate the power save category in relation to at least one of power save feature or a power save mode of an operation. The default power save category is indicated in a capability information element of the STA, wherein the power save category is associated with the power save feature and a mode of an operation is indicated in the power save capability.

Further, embodiments herein disclose determining that a dynamic power save mode is supported; and setting a power save category associated with a low power and high-power mode in response to determining that the dynamic power save mode is supported.

Further, embodiments disclosed herein determine that a scheduled power save mode is supported and setting the power saving category associated with at least one of a low or doze mode or an active mode in response to determining that the scheduled power save mode is supported.

Further, embodiments herein disclose determining that a cross-link power management mode is supported and setting a power save category associated with each link in response to determining that the cross-link power management mode is supported.

Therefore, embodiments herein provide power save category with the indication of the power save mode changes. The devices can decide to operate in low power mode when there is not much traffic and can change their power save mode preferences to high power mode when a new application requires high performance in throughput. The AP and STA need to communicate the power save mode preference changes.

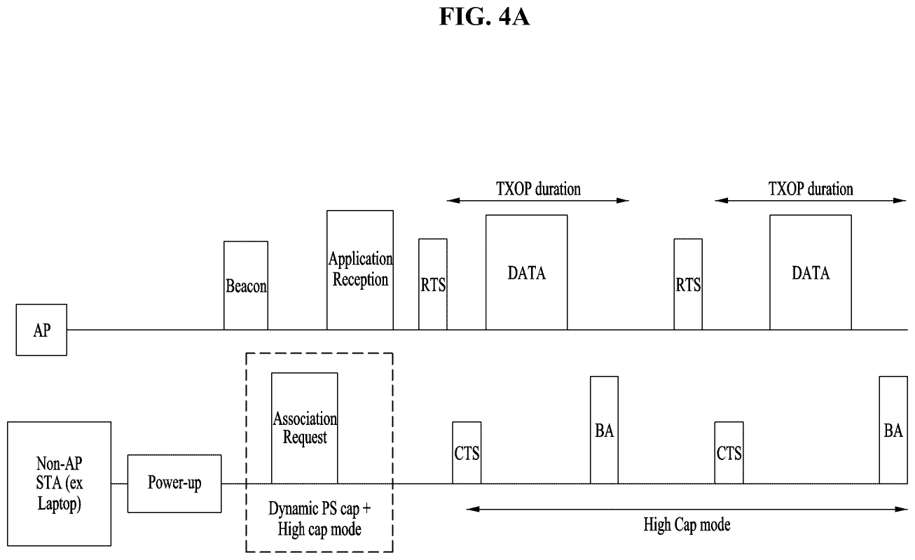

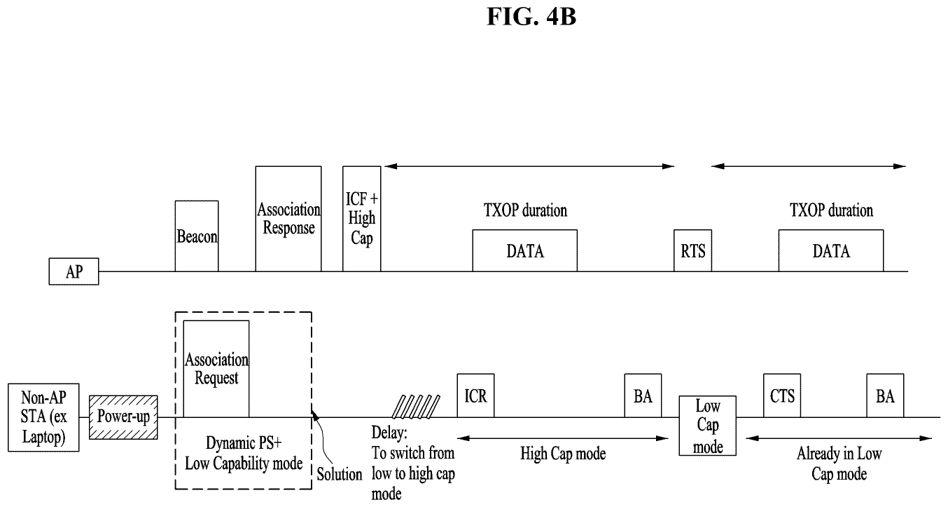

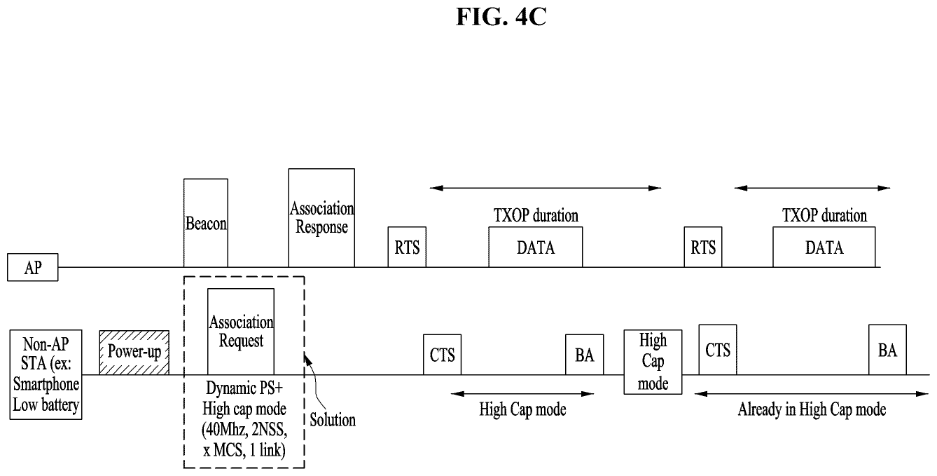

As illustrated in FIG. 4A, the non-AP STA like laptop 400d has set its default power save mode as high capability mode. After power up, the non-AP STA reads the beacon from AP and its associated capabilities and sends an association request message. The Association Request message comprises a dynamic PS mode (with high capability) whose frame format and contents are as described in various options from FIG. 2B to FIG. 3E.

AP sends an association response. AP already knows that the non-AP STA is in high capability mode, when it needs to send data to the STA, it can send RTS-CTS (Request to Send-Clear to Send) with data following it using high capability mode configuration.

The advantage is there is no delay in changing mode from high capability to low capability mode and vice versa. Based on the need of the non-AP STA, it can change its default mode of operation and provide a more optimized behaviour.

As illustrated in FIG. 4B, a non-AP STA like IoT device 400a, which does not have high throughput kind of requirements has set its default power save mode as low capability mode. After power up, the non-AP STA reads the beacon from AP and its associated capabilities and sends an association request message. The association request message as per the current solution also includes a dynamic PS mode (with low capability) whose frame format and contents are as described in in various options from FIG. 2B to FIG. 3E. AP 410 sends an association response. Since AP 410 already knows that the non-AP STA is in low capability mode, if there is requirement to send large PPDU, it can request the non-AP STA to move to high capability mode using ICF (as per ongoing proposals in the standard).

Therefore, the ICF provides enough padding or delay to ensure that the non-AP STA can move to high capability mode for the TXOP duration. Once the TXOP is completed, it can go back to the default low capability mode. Further data requirements for an IoT device 400a may not require it to transition to high capability mode and hence a simple RTS-CTS with data can suffice without requiring to switch it to high capability mode. The advantage is that the device continues to remain in low capability mode as its default mode as per its requirements.

In another scenario as illustrated in FIG. 4C, it is possible to send the associated BW, NSS, MCS, link for the high or low capability default mode that the STA is going to operate in. In this example, a smartphone is having low battery, hence it is going to restrict its max BW, NSS, links etc to 40 Mhz, 2NSS, 1 link etc and indicates that the high capability mode is associated with this configuration.

Thereafter, the RTS-CTS can control the PPDU configuration, and the STA need not spend extra padding or delay in switching to the high capability mode again and again. The default power save mode provides the flexibility to enable this configuration and saves on the delay in switching BW, links etc.

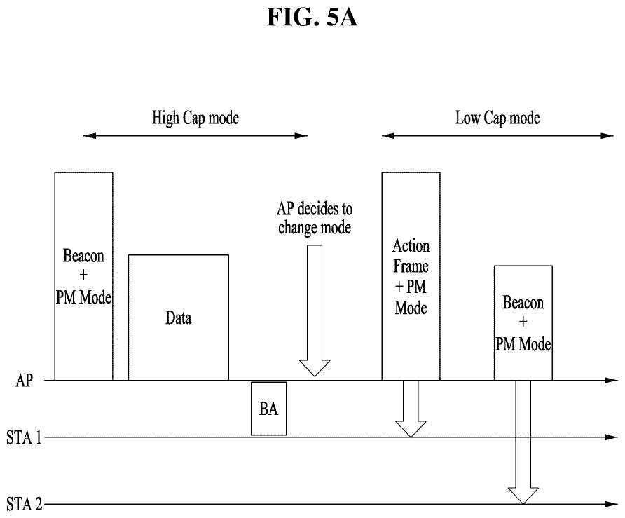

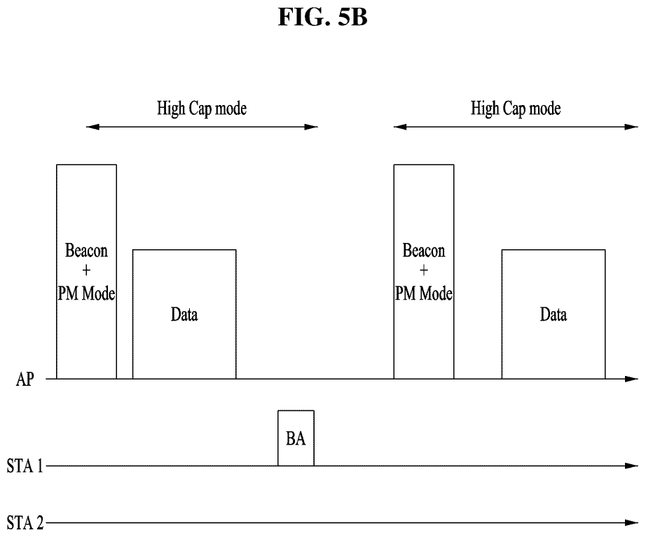

FIGS. 5A and 5B depict example scenarios, wherein the AP or STA can determine that there is a need to change or update the low or high capability modes of operation for specific power save features like DPS. This change or update can be indicated in any other additional action/control/management/beacon frame. The message can be sent in unsolicited manner irrespective of data activity when the STA or AP can sense that it is better for it to remain or change its current power save state.

In an example scenario depicted in FIG. 5A, the AP is operating in a high capability mode, and it informs its configuration via a beacon and continues data transmission to STA1. After data transmission, the AP sees an opportunity to save the power and decides to go to low power mode. In this low power mode, the AP can have flexibility to listen to small bandwidth, 1 SS, 1 link or multiple links based on implementation and requirements. Hence, the AP can update its changed mode through an Action Frame to all its associated STAs. However, when a new STA2 gets associated with this AP in the same BSS, it shall read the beacon to understand the current power save mode. The frame format of action frame or information elements within beacon frame is as described in various options from FIG. 2B to FIG. 3E.

In an example scenario depicted in FIG. 5B, STA1 and STA2 are associated with the AP. The AP is transmitting in high capability mode first to STA1 and then to STA2. STA1 decides that it wants to remain in high capability mode as there is a high throughput requirement currently ongoing and it does not wish to keep going back to low power mode at end of TXOP. The initial power save mode has already been communicated by STA1. The current power save mode of AP in this scenario, will be a much higher capability than the lowest which is usually 20 Mhz, 1NSS etc.

However, STA2 sees an opportunity to go to low power mode immediately after sending Block Ack. A flexibility is needed at the STAs to send power management mode changes irrespective of TXOP, as users these days are provided with control at the UX and it helps in moving to power save modes faster.

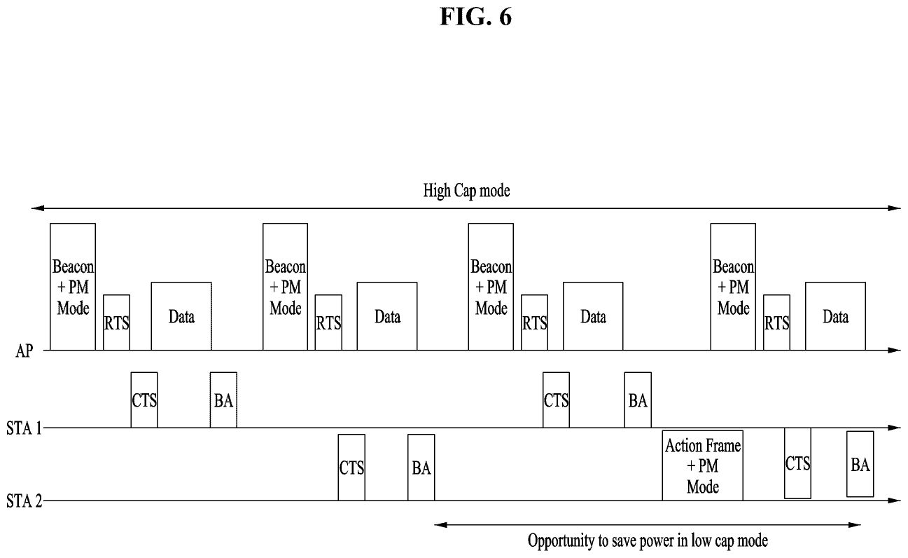

FIG. 6 depicts an example scenario, wherein the power save mode save indication is performed based on STA1 and STA 2 associated with AP. In the scenario depicted in FIG. 6, both STA1 and STA2 are connected to AP (Access Point). The AP transmits data to STA1 in high capability mode, followed by transmitting to STA2. STA1 has high throughput requirements and stays in high capability mode, avoiding a return to low power mode at the end of the transmission opportunity (TXOP). STA1 had previously communicated its power save mode to the AP.

However, if STA2 notices that there isn't much data exchange with the AP, it switches to a low power mode. STA2 sends an action frame with its power management mode set to low capability mode with associated operating parameters like bandwidth, NSS, MCS and informs the AP. The AP, on identifying the mode of STA2, adjusts the next data exchange with STA2 accordingly. The AP can send data using RTS-CTS (Request to Send-Clear to Send) in low capability mode without any delays caused by mode changes.

Therefore, flexibility for STAs to send power management mode changes even outside of their designated transmission opportunities (TXOP). As modern devices offer users control through the user interface (UX), it becomes easier to switch to power save modes more quickly. Hence, devices can send unsolicited frames outside of TXOP when users put the device into different modes, such as sleep mode, or power save mode. Provides quicker transitions to power-efficient states based on user preferences.

The power save mode change indication can be sent as per prior art in ICF based on the data. However, the power save mode change indication can be sent in any other additional action/control/management/beacon frame. The message can be sent in unsolicited manner irrespective of data activity when the STA or AP can sense that it is better for it to remain or change its current power save state. The contents of the message or frame format can be as described in various options from FIG. 2B to FIG. 3E and the message sequence of the claimed invention as shown in FIG. 4A and FIG. 6.

In some examples, when certain scenarios occur where the STA or AP decides to remain in the high-power state, it can indicate the same in the ICF which was used for changing the power save mode from low capability mode to high capability mode. In the ICF, a 1-bit indication can be sent which is a flag to indicate that it shall remain in the high-power state until another message is received to change the power save mode. The encoding is shown in Table 3.

TABLE 3

| Subfield | Encoding |
|---|---|
| 1 | Continue High capability mode |
| 0 | Revert back to low capability mode |

Section 3 in power save categories examples herein define one or more power save categories. They provide two variants of mapping for single link or multi-link devices. The power save category can be defined to include the different power save profiles that map the associated bandwidth, Spatial streams, MCS, number of links etc. The power save category mapping can be defined as shown in Tables 4A or 4B. In Table 4A, links are not included, while in Table 4B, the power save category includes links as an alternative solution. Table 4B shows the mapping of power save category values to related BW, NSS, MCS schemes and links. The values can be defined to be from 0 to N where N is determined when actual values are defined in the specifications. A number of combination of values are defined in the Table to include different bandwidths from 20 MHz to 320 MHz, NSS from 1 to X where N can be dependent on max that the device supports like 2, 4, 8 etc. MCS can indicate the max modulation and coding scheme supported from QPSK to 4096 QAM or even higher if it is defined in 802.11bn specification.

The number of links can also depend on max links supported which can be 1, 2 or 3 or higher. The fundamental concept is the Table of power save category mapping can include all the combinations of BW, NSS, MCS and/or links to associated integer values in the range 1 to N where N will be determined at the time of defining the specifications.

TABLE 4A

| Value | Power Save Category | BW | NSS | MCS |
|---|---|---|---|---|
| 0 | PC_Max | 20 MHz | 1 | QPSK |
| 1 | PC_Mid_1 | 40 MHz | 1 | QPSK |
| . . . | . . . | | | |
| N | PC_Min | 320 MHz (or | N | 4096QAM |
| | | highest | | |
| | | supported) | | |

TABLE 4B

| | Power Save | | | | |
|---|---|---|---|---|---|
| Value | Category | BW | NSS | MCS | Links |
| 0 | PC_Max | 20 MHz | 1 | QPSK | 1 |
| 1 | PC_Mid_1 | 40 MHz | 1 | QPSK | 1 |
| . . . | . . . | | | | |
| N | PC_Min | 320 MHz (or | N | 4096QAM | n |
| | | highest | | | |
| | | supported) | | | |

The value mapping to PC_levels can be utilized to indicate the profile of BW, NSS, MCS, links etc.

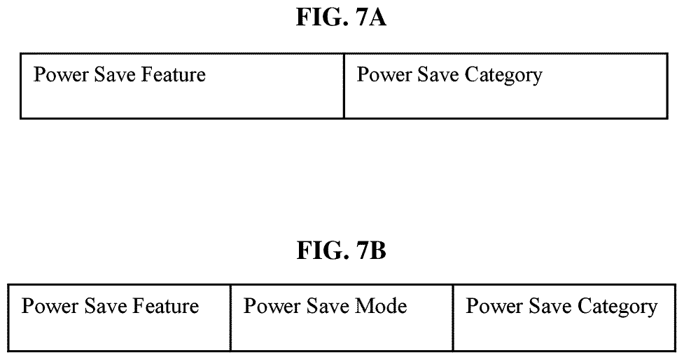

The frame format that shall include a power save category is shown in FIG. 7A and FIG. 7B. These are different variants of the frame format and both type of formats is defined. The power save feature can indicate a value to point to many of the candidate power save features under consideration for 802.11bn specifications that includes Dynamic power save, scheduled power save etc. The power save category value is the associated number for that feature.

These set of sub-fields can be used in any control or action or management frame formats like beacons, association request/response, power save mode indicators and so on. The purpose is to indicate what is the mapped value of bandwidth, NSS, MCS and/or links for the given power save feature and its mode of operation.

Consider frame format as shown in FIG. 7B, wherein a dynamic power save feature information is filled here where the low power mode shall operate at category 0 that implies encoding as per Table 4A or Table 4B based on single or multi-link operation and the high-power mode can indicate the category 5 from Table 4A/4B.

In the power save mode indication, the power save feature and its associated category can be indicated instead of individually indicating the BW, NSS, MCS etc. FIG. 7A depicts a frame format for indicating the power save feature and its associated category. The associated frame format is shown in FIG. 7A and Table 5.

TABLE 5

| Sub-field | Definition | Encoding |
|---|---|---|
| Power Save | This field indicates the type of | 00 - Power save features OFF |
| Feature | power save feature | 01- Dynamic Power save feature is |
| | | ON and others are OFF |
| | | 10 - Scheduled power save feature is |
| | | ON and others are OFF |
| | | * Can be extensible in the future |
| Power Save | This field indicates power save | Encoding as per Table 4A or Table |
| Category | category which is a profile of the | 4B values |
| | power save parameters associated | |
| | to the category of the STA | |

Power save category in capabilities, wherein the power save capabilities including the feature, mode and associated profile be sent via capabilities using the power save category defined above (Tables 4A, 4B, FIG. 7A, and Table 5). The advantage of this method is that, instead of sending across the complete profile in capability, space can be optimized in the messages that carry the power save capabilities like Beacon, (re) association request/response, probe request/response. Embodiments herein define a frame format for power save capabilities. Embodiments herein define a power save category to indicate the default power save mode.

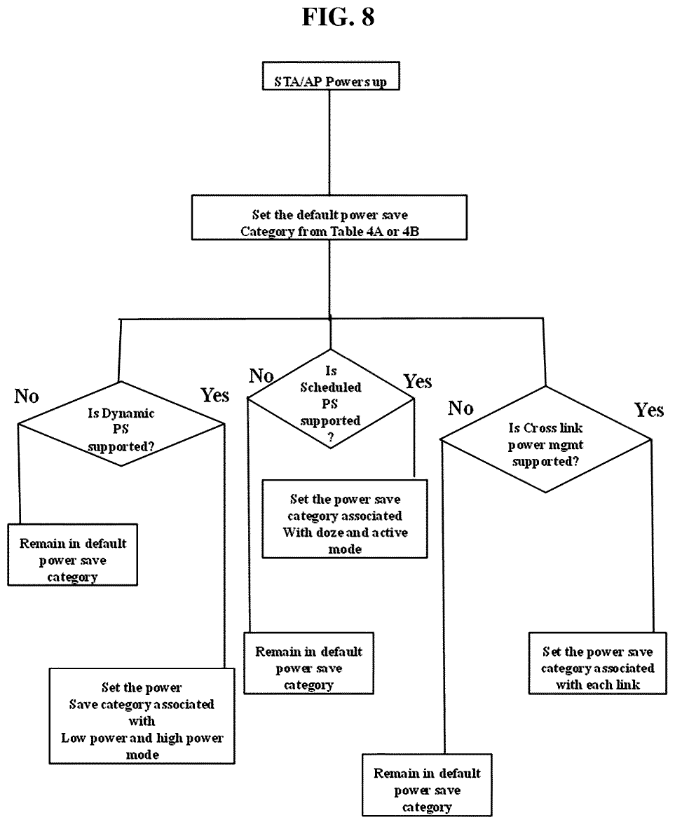

As illustrated, FIG. 8 is an example flow diagram depicting the power save category of the STA. The capabilities are sent in Beacon, Association Request/Response, probe request/response messages. A default power save category value is set based on Table 4A or Table 4B depending on the implementation dependencies. Default power save category is chosen based on what the STA or AP wants to be in at the time of first association or power up. Further based on the type of power save feature supported in the device like dynamic PS, scheduled PS or cross link power management, the associated power save category is updated. For each feature, usually a high or low power save mode is defined. An associated power save category for the low/doze power mode and for high or active power save mode is set in power save capabilities. Similarly for cross link power management, further optimized solution can include the power save category capability per link.

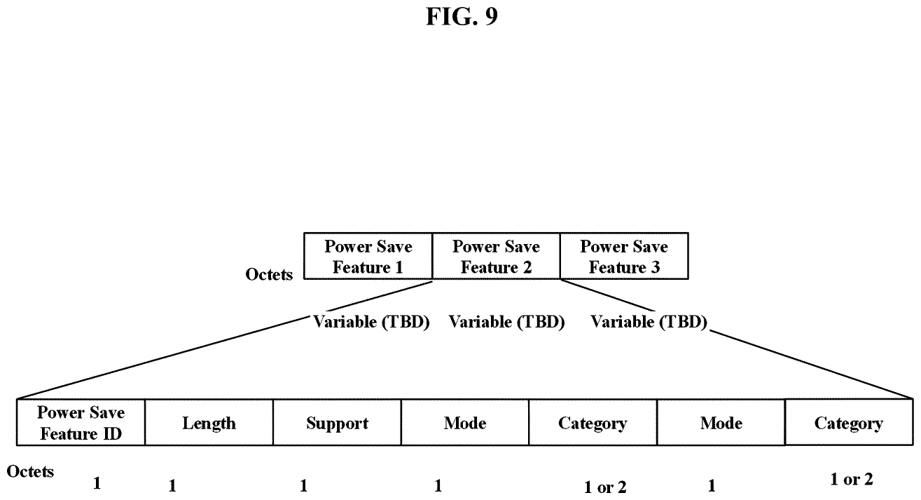

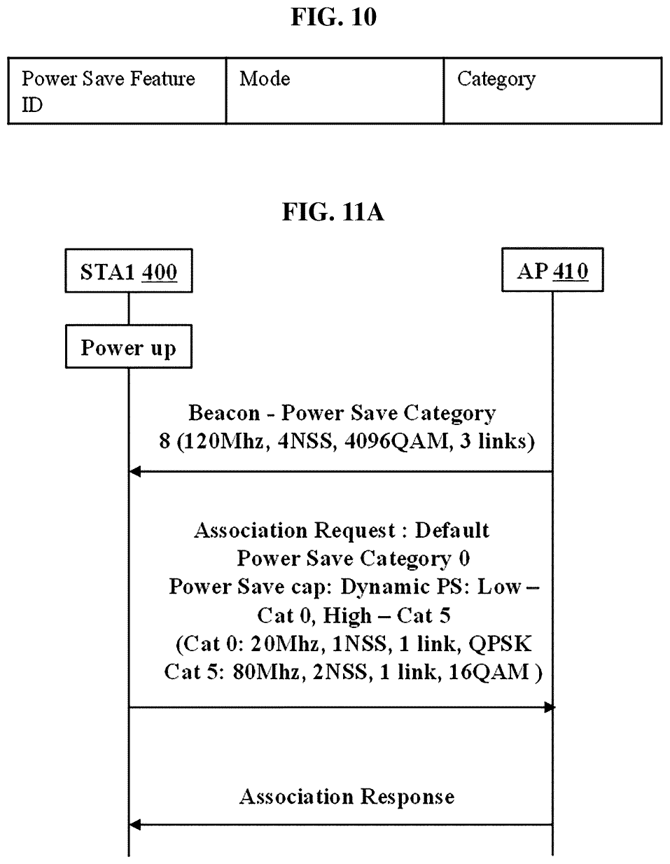

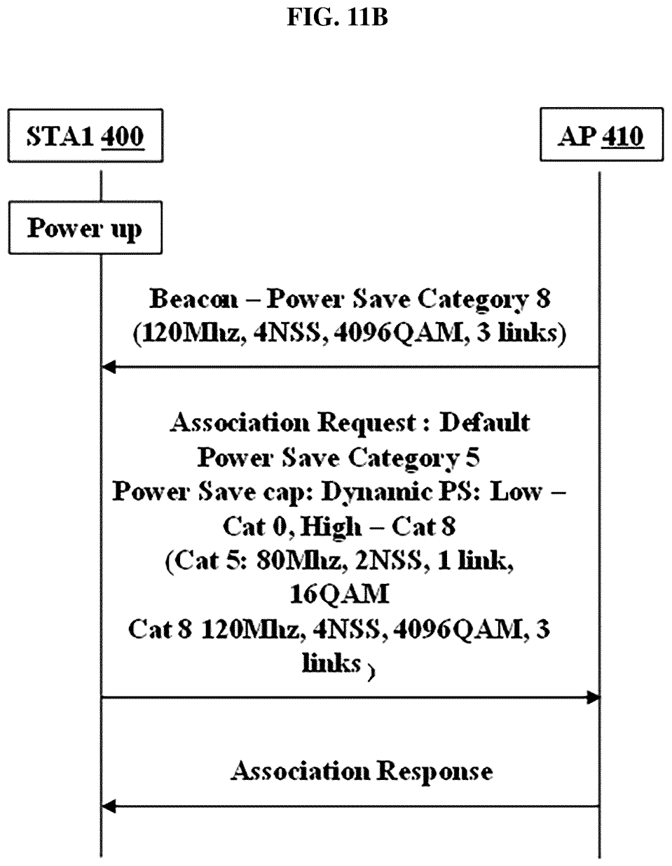

FIG. 9 depicts the frame format for each power save feature. The frame format is defined that contains a set of power save features. In Tgbn, there are multiple features such as scheduled power save, dynamic power save, cross link power save etc. Hence the frame format shall include method to include all the types of power save features. The message can be indicated in UHR capabilities information element or can be included in a newly defined power save capabilities element etc. The capabilities itself is sent in Beacon, Probe Request/Response, (Re) Association Request/response etc.

FIG. 9 shows the frame format for each feature. Each feature itself is further defined to have support for identifying the power save feature ID, its support, mode of operation and its associated category. The details are provided in Table 6, which depicts the frame format for power save category wise capabilities.

TABLE 6

| Sub-field | Definition | Encoding |
|---|---|---|
| Power Save | This indicates the power save | Example: |
| Feature ID | feature ID from different | 1 - Dynamic Power Save |
| | power save features | 2 - Scheduled Power Save |
| | implemented or defined in | 3 - Cross link power save |
| | Tgbn | |
| Length | This indicates the length of | |
| | the power save feature | |
| | capability information | |
| Support | This indicates whether the | 1 - Yes |
| | associated feature is | 0- No |
| | supported or not | |
| Mode | This field indicates the power | 0- Low power (Doze, or |
| | save mode for which the | Low power state) |
| | associated category is | 1- High power (Active, or |
| | indicated | high-power state) |
| | | Can be extensible |
| Category | This shall indicate the power | This can take values 0 to N |
| | save category option for the | as defined in Table 4A/4B |
| | associated mode in previous | |
| | field | |

FIG. 10 depicts the frame format to indicate the power save mode. Default power save category, wherein the power save category is useful to additionally also indicate the power save category that a device by default wishes to operate on (re) association or from an AP perspective can indicate the preferred or current power save mode in the beacons. This frame can be included in Beacon, (Re) Association Request/Response, Probe Request/Response. The frame format to indicate the power save mode can be as follows in FIG. 10 and Table 7.

TABLE 7

| Sub-field | Definition | Encoding |
|---|---|---|
| Power Save | This indicates the power save | Example: |
| Feature ID | feature ID from different | 1 - Dynamic Power Save |
| | power save features | 2 - Scheduled Power Save |
| | implemented or defined in | 3 - Cross link power save |
| | Tgbn | |
| Mode | This field indicates the power | 0- Low power (Doze, or |
| | save mode for which the | Low power state) |
| | associated category is | 1-High power (Active, or |
| | indicated | high-power state) |
| | | Can be extensible |
| Category | This shall indicate the power | This can take values 0 to N |
| | save category option for the | as defined in Table 4A/4B |
| | associated mode in previous | |
| | field | |

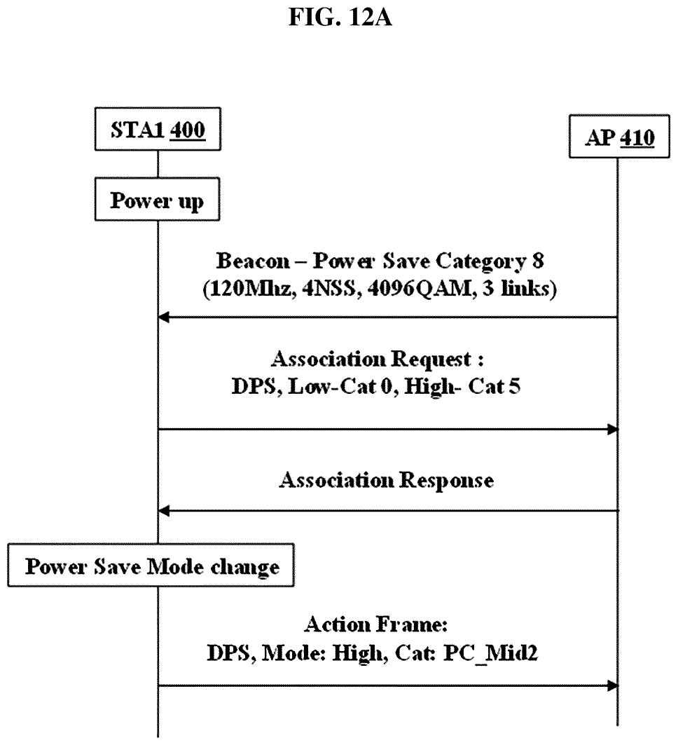

FIGS. 11A and 11B are example sequence diagrams illustrating the usage of power save categories in capabilities. FIG. 11A shows STA1 400, for example, like a wearable device that has lower battery capacity and also performance requirements. When the STA1 powers up and reads the beacon from the AP 410, it reads the power save category capabilities of AP. In this illustration, a category 8 is indicated which for sake of illustration is shown to include 120 Mhz BW, 4 spatial streams, 3 links and 4096 QAM MCS capabilities.

However, the STA1 is not having requirement of such high capacity and would rather save its battery. STA1 indicates in association request that it shall prefer to operate in default power save category of 0 and support dynamic power save feature that shall enable an operation of low power mode of Cat 0 and high-power mode of Cat 5.

Without the need to indicate the elaborate definitions of cat 0 or cat 5, STA1 is able to exchange that it shall operate with the associated BW, link, antenna and MCS as defined for Cat 0 or Cat 5. Similarly, this method is used for other high-performance devices like a smartphone which is supporting gaming or live streaming etc, to operate in higher capabilities illustrated in FIG. 11B, wherein the STA2 (not shown) on power up reads beacon from AP and sends an association request indicating its default power save category and power save feature support with its associated high and low power save categories.

In this example, the smartphone STA2, can operate in a low power category of CAT 5 which in itself is operating at 80 Mhz bw, 2 NSS, 1 link and a high-power category of CAT 8 which indicates 120 Mhz, 4NSS, 4096QAM and so on.

Flexibility is provided for the AP and STA to indicate different power save categories based on the need, implementation dependencies and performance requirements.

Power save category for power save mode change, power save category is used when we need to indicate the power save mode changes. Devices can decide to operate in low power mode when there is not much traffic and can change their power save mode preferences to high power mode when a new application requires high performance in throughput, for example. In such scenarios, the AP and STA need to communicate the power save mode preference changes. Due to the different hardware capabilities and the flexibility to operate in different links, bandwidth, spatial streams and coding rates—the power save profile can be chosen as per the dynamic requirements of the application. The power save mode change message itself can be indicated in an Action frame/control frame/management frame/beacon or any other new message for power save mode. The frame format including the power save category for mode change is shown in FIG. 10 and Table 7.

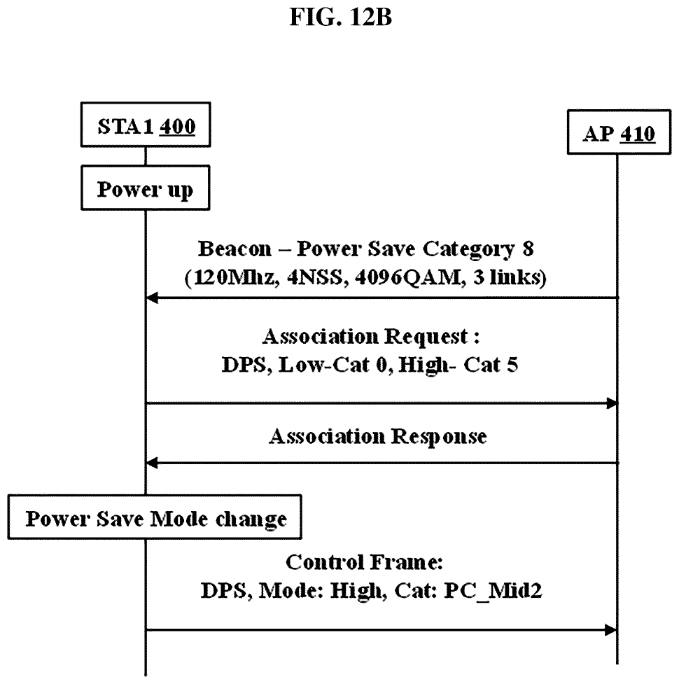

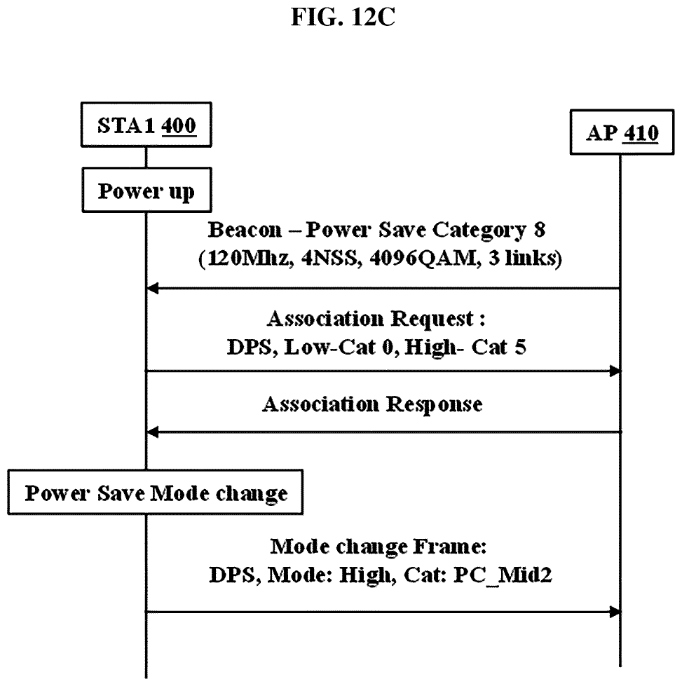

FIGS. 12A, 12B and 12C are example sequence diagrams illustrating the power save mode change. The message can be sent from AP to STA or STA to AP. The message can be an action frame, control frame or a new management frame like power save mode change frame. The message sequence illustrates that whenever a STA or AP decide to change power save mode, for example it needs high power due to performance requirement or it needs to operate in low power mode due to battery shortage, an indication can be sent that it shall operate in this mode until further notice.

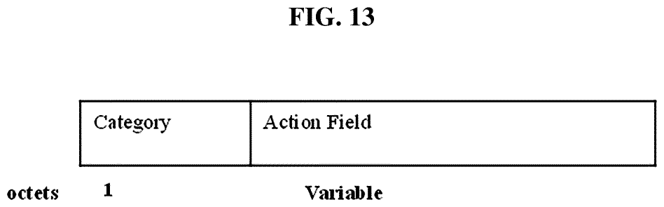

FIG. 13 illustrates an action frame associated with the category and action field. Category values relate to a new value defined for UHR power save mode change.

TABLE 8A

| | | | | Group |
|---|---|---|---|---|
| | | | | addressed |
| Code | Meaning | Sub-clause | Robust | Privacy |
| 1-34 | <<As per current specification>> | | | |
| XX (number | UHR Power | Frame format as | Yes | No |
| between | save mode | specified in | | |
| 35-125) | change | FIG. 12, Table 7 | | |

| | |
|---|---|
| 126-127 | Vendor Specific |

A protected Action frame can also be defined in UHR version of specification as shown below where the category is defined as shown and the format of the frame can be as shown below.

TABLE 8B

| Order | Meaning |
|---|---|
| 1 | Category |
| 2 | Protected UHR Action |
| 3 | Dialog Token |
| 4 | Frame format as specified in FIG. 11, Table 7 |

As illustrated in FIG. 13 and Table 8A/8B, an action frame can be used to send a power save mode change indication. To define the details, a new category for UHR Power save mode change shall be defined.

For control frames, there is usually a control frame type and sub type defined. Hence to indicate power save mode change, we need to define the new control frame type and sub type values.

TABLE 9

| | | Control Frame | |
|---|---|---|---|
| Type | Sub-Type | Extension value | Description |
| 01 | 0110 | XXXX (Values | UHR Power save |
| | | from reserved | mode change |
| | | value 1100-1111) | |

The control frame extension value can be assigned to UHR power save mode change from one of the reserved values whose exact value can be determined at the time specification are drafted. The description of this value will be to indicate a UHR power save mode change indication. The frame format as illustrated in FIG. 10, and Table 7. Alternatively, an A-Control for UHR can also be defined that can include the power save feature, power save category and indicate the change through this message.

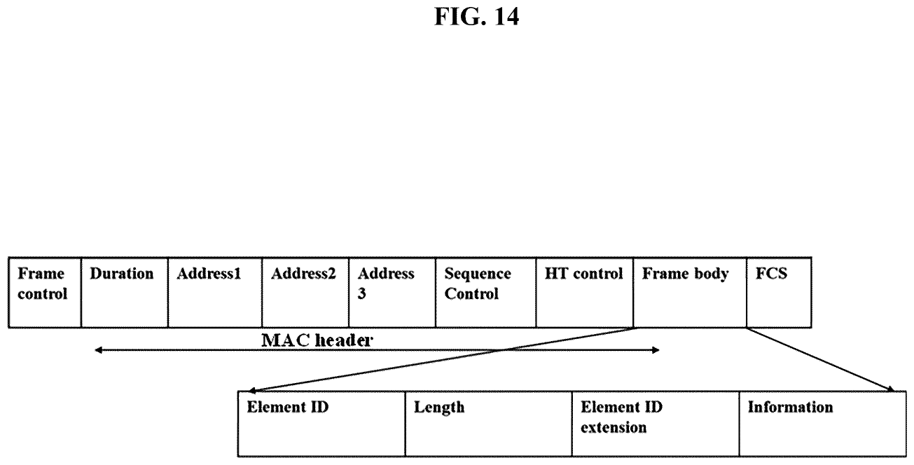

FIG. 14 is an example diagram illustrating the frame format defined as a management frame with associated element ID/extension ID. An embodiment as disclosed herein, a new frame format can be defined only to exchange the power save mode change information. The frame format can be defined as a management frame with associated element ID/extension ID defined. The frame body can consist of details as defined in FIG. 10, Table 7 in the information field.

TABLE 10A

| Type | Description | Sub type value | Sub type description |
|---|---|---|---|
| 00 | Management | XXXX (Reserved | PS mode change |
| | | value) | |

TABLE 10B

| | Element | Element ID | | |
|---|---|---|---|---|
| Element | ID | extension | Extensible | Fragmentable |
| PS mode | YY | ZZ | No | No |
| change | | | | |

The frame control field has a new management type defined for PS mode change as shown in Table 10A. Its associated element ID is defined as shown in Table 10B.

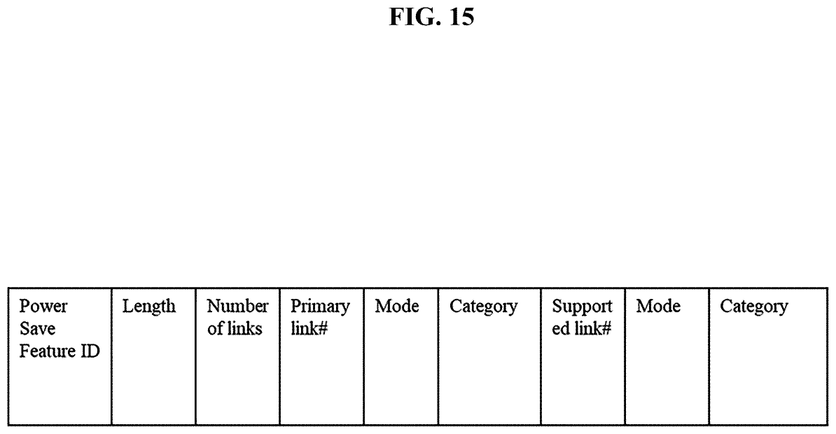

FIG. 15 depicts the frame format for power save mode indication in cross link power save. Power save mode indication in cross link power save, while in Tgbn discussions, a cross link power save mode is described which allows a non-AP MLD to indicate to its associated AP MLD that supports the mechanism, in a frame sent on one enabled link, the power management mode of one or more of its affiliated non-AP STAs. With the introduction of power save categories, more information can be shared by one link about its associated other links. A non-AP MLD can indicate to its associated AP MLD about the power save mode and its category in a frame. This has more information than just the power save mode and hence can be more useful in determining the power management on per link basis. The associated frame format can be considered as follows in FIG. 9 and Table 8A.

TABLE 11

| Sub-field | Definition | Encoding |
|---|---|---|
| Power Save | This indicates the cross-link power save | This indicates the value |
| Feature ID | feature ID | associated with cross link |
| | | power save feature ID |
| Length | This indicates the length of the power save | This field is present if the |
| | feature capability information | feature is supported. Else |
| | | absent. |
| Number of links | This indicates how many links support | |
| | cross link power save mechanism | |
| Primary Link# | This field indicates whether a primary link | 00 - Any link can be a |
| | is identified for cross link operations or any | primary link |
| | link can be used to update the power | XX - Link ID# of primary |
| | management modes of other links | link |
| Supported Link | This field shall indicate the link ID of the | XX - Link ID# if cross link |
| # | all the links that shall support cross link | power save is supported on |
| | power save mode with category support | this link |
| | indication | |
| Mode | This field indicates the power save mode | 0- Low power (Doze, or Low |
| | for which the associated category is | power state) |
| | indicated for the associated link | 1-High power (Active, or |
| | | high-power state) |
| | | Can be extensible |
| Category | This shall indicate the power save category | This can take values 0 to N as |
| | option for the associated mode in previous | defined in Table 1 |
| | field for the associated link | |

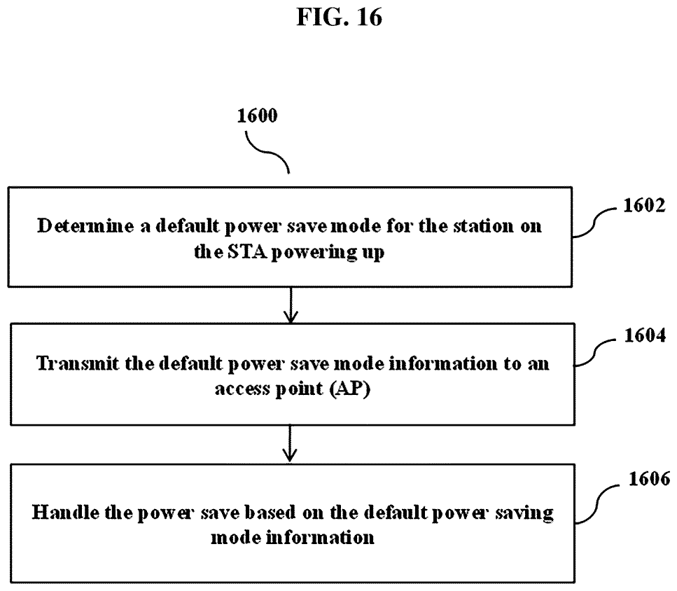

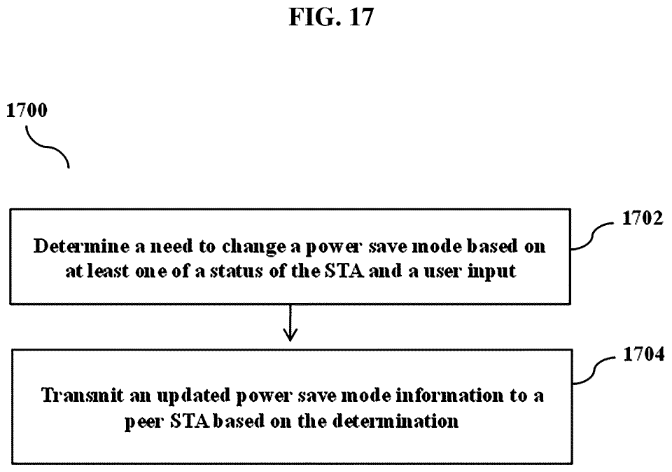

FIG. 16 and FIG. 17 are flow charts (1600 and 1700) illustrating a method for controlling power save in the WLAN, according to an embodiment.

As shown in FIG. 16, at 1602, the method includes determining a default power save mode for the station upon the STA powering up. At 1604, the method includes transmitting the default power save mode information to the AP. At 1606, the method includes controlling the power saving based on the default power save mode information.

As shown in FIG. 17, at 1702, the method includes determining a need to change a power save mode based on at least one of a status of the STA or a user input. At 1704, the method includes transmitting the updated power save mode information to an AP based on the determination.

The embodiments disclosed herein describe systems and methods for managing the power save mode in Ultra High Reliability (UHR) networks.

One aspect of the present disclosure provides a station (STA) in a wireless network. The STA comprises at least one processor including processing circuitry and memory storing instructions. The instructions, when executed by the at least one processor individually or collectively, cause the STA to determine a need to indicate a power save mode including at least one of enablement or update based on at least one of a status of the STA or a user input. The instructions, when executed by the at least one processor individually or collectively, further cause the STA to transmit an updated power save mode information that includes at least one associated configurable parameter associated with power save to a peer STA based on the determination.

In some examples, the updated power save mode information is transmitted to the peer STA irrespective of data activity.

In some examples, the instructions, when executed by the at least one processor individually or collectively, further cause the STA to determine a default power save mode for the station, when the STA powers up. The instructions, when executed by the at least one processor individually or collectively, further cause the STA to transmit a default power save mode information and at least one configurable operating mode capability to the peer STA, based on the default power save mode. The instructions, when executed by the at least one processor individually or collectively, further cause the STA to control power saving based on the default power save mode information.

In some examples, the updated power save mode information is transmitted to the peer STA based on at least one frame format. The at least one frame format comprising at least one of: a management frame format, an action frame format, a control frame format, or a beacon frame format to indicate at least one enablement or update of operational parameters for the associated power save mode and feature.

In some examples, the at least one frame format indicates a power saving feature or the power save mode

In some examples, the at least one frame format indicates at least one of a power saving feature, a power save mode, operational parameters: bandwidth (BW), a number of spatial streams (NSS), a modulation and coding scheme (MCS), or link information for at least one enablement or update of power save mode.

In some examples, the instructions, when executed by the at least one processor individually or collectively, further cause the STA to transmit an indication of the default power save mode via at least one of: a beacon frame, a re-association request frame, a re-association response frame, a probe request frame or a probe response frame.

In some examples, the default power save mode information comprises at least one of: a type of power save mode, a power save mode feature, operational parameters, bandwidth (BW), a number of spatial streams (NSS), a modulation and coding scheme (MCS), or a link information.

In some examples, the instructions, when executed by the at least one processor individually or collectively, further cause the STA to transmit an indication of a power saving category to the peer STA.

In some examples, the transmitting of the indication of the power saving category comprises configuring a power saving category included in different power save features and different power save modes. In some examples, the transmitting of the indication of the power saving category comprises transmitting an indication of a default power save category based on determining the default power save mode of operation. In some examples, the transmitting of the indication of the power saving category comprises determining a need to transmit the power saving category to the peer STA when at least one of: the STA powers up or the power saving category changes. In some examples, the transmitting of the indication of the power saving category comprises transmitting the modified power saving category to the peer STA.

In some examples, a mapping table is utilized for at least one of: at least one single-link operation or at least one multi-link operation in the power saving category.

In some examples, the power saving category is indicated using a frame structure, wherein the power saving category includes at least one of a bandwidth (BW), a number of spatial streams (NSS), a modulation and coding scheme (MCS), or link information.

In some examples, the frame structure indicates the power saving category associated with at least one of a power saving feature or a power save mode of an operation.

In some examples, the default power save category is indicated in a capability information element of the STA.

In some examples, the power saving category is associated with a power saving feature and a mode of an operation is indicated in a power saving capability information element of the STA.

In some examples, the instructions, when executed by the at least one processor individually or collectively, further cause the STA to determine that a dynamic power save mode is supported. In some examples, the instructions, when executed by the at least one processor individually or collectively, further cause the STA to set a power saving category associated with a low power and high-power mode in response to determining that the dynamic power save mode is supported.

In some examples, the instructions, when executed by the at least one processor individually or collectively, further cause the STA to determine that a scheduled power save mode is supported. In some examples, the instructions, when executed by the at least one processor individually or collectively, further cause the STA to set the power saving category to be associated with at least one of: a low capability mode or a high capability mode in response to determining that the scheduled power save mode is supported.

In some examples, the instructions, when executed by the at least one processor individually or collectively, further cause the STA to determine that a cross-link power management mode is supported. In some examples, the instructions, when executed by the at least one processor individually or collectively, further cause the STA to set a power saving category associated with each link in response to determining that the cross-link power management mode is supported.

In some examples, the instructions, when executed by the at least one processor individually or collectively, further cause the STA to determine whether the peer STA remains in at least one of a high capability mode or a low capability mode. In some examples, the instructions, when executed by the at least one processor individually or collectively, further cause the STA to transmit an indication in an Initial Control Frame (ICF) to indicate to the peer STA that upon receiving a notification, the peer STA shall remain in at least one of the high capability mode or the low capability mode.

One aspect of the present disclosure provides a computer-implemented method for wireless communication by a station (STA) in a wireless network. The method comprises determining, by a station (STA), a need to indicate a power save mode including at least one of enablement or update based on at least one of a status of the STA or a user input. The method comprises transmitting, by the STA, an updated power save mode information that includes at least one associated configurable parameter associated with power save to a peer STA based on the determination.

In some examples, the updated power save mode information is transmitted to the peer STA irrespective of data activity.

In some examples, the method comprises determining, by the STA, a default power save mode for the station, when the STA powers up. The method comprises transmitting, by the STA, a default power save mode information and at least one configurable operating mode capability to the peer STA, based on the default power save mode. The method comprises controlling, by the STA, power saving based on the default power save mode information.

In some examples, the updated power save mode information is transmitted to the peer STA based on at least one frame format. The at least one frame format comprising at least one of: a management frame format, an action frame format, a control frame format, or a beacon frame format to indicate at least one enablement or update of operational parameters for the associated power save mode and feature.

In some examples, the at least one frame format indicates a power saving feature or the power save mode

In some examples, the at least one frame format indicates at least one of a power saving feature, a power save mode, operational parameters: bandwidth (BW), a number of spatial streams (NSS), a modulation and coding scheme (MCS), or link information for at least one enablement or update of power save mode.

In some examples, the method comprises transmitting, by the STA, an indication of the default power save mode via at least one of: a beacon frame, a re-association request frame, a re-association response frame, a probe request frame or a probe response frame.

In some examples, the default power save mode information comprises at least one of: a type of power save mode, a power save mode feature, operational parameters, bandwidth (BW), a number of spatial streams (NSS), a modulation and coding scheme (MCS), or a link information.

In some examples, the method comprises transmitting, by the STA, an indication of a power saving category to the peer STA.

In some examples, the transmitting of the indication of the power saving category comprises configuring, by the STA, a power saving category included in different power save features and different power save modes. In some examples, the transmitting of the indication of the power saving category comprises transmitting, by the STA, an indication of a default power save category based on determining the default power save mode of operation. In some examples, the transmitting of the indication of the power saving category comprises determining, by the STA, a need to transmit the power saving category to the peer STA when at least one of: the STA powers up or the power saving category changes. In some examples, the transmitting of the indication of the power saving category comprises transmitting, by the STA, the modified power saving category to the peer STA.

In some examples, a mapping table is utilized for at least one of: at least one single-link operation or at least one multi-link operation in the power saving category.

In some examples, the power saving category is indicated using a frame structure, wherein the power saving category includes at least one of a bandwidth (BW), a number of spatial streams (NSS), a modulation and coding scheme (MCS), or link information.

In some examples, the frame structure indicates the power saving category associated with at least one of a power saving feature or a power save mode of an operation.

In some examples, the default power save category is indicated in a capability information element of the STA.

In some examples, the power saving category is associated with a power saving feature and a mode of an operation is indicated in a power saving capability information element of the STA.

In some examples, the method comprises determining, by the STA, that a dynamic power save mode is supported. In some examples, the method comprises setting, by the STA, a power saving category associated with a low power and high-power mode in response to determining that the dynamic power save mode is supported.

In some examples, the method comprises determining, by the STA, that a scheduled power save mode is supported. In some examples, the method comprises setting, by the STA, the power saving category to be associated with at least one of: a low capability mode or a high capability mode in response to determining that the scheduled power save mode is supported.

In some examples, the method comprises determining, by the STA, that a cross-link power management mode is supported. In some examples, the method comprises setting, by the STA, a power saving category associated with each link in response to determining that the cross-link power management mode is supported.

In some examples, the method comprises determining, by the STA, whether the peer STA remains in at least one of a high capability mode or a low capability mode. In some examples, the method comprises transmitting, by the STA, an indication in an Initial Control Frame (ICF) to indicate to the peer STA that upon receiving a notification, the peer STA shall remain in at least one of the high capability mode or the low capability mode.

One aspect of the present disclosure provides an access point (AP) in a wireless network. The AP comprises at least one processor including processing circuitry and memory storing instructions. The instructions, when executed by the at least one processor individually or collectively, cause the AP to receive a default power save mode information from the STA. The instructions, when executed by the at least one processor individually or collectively, cause the AP to receive an updated power save mode information that includes at least one associated configurable parameter associated with power save to a peer STA.

In some examples, the default power save mode information comprises at least one of: a type of power save mode, a power save mode feature, operational parameters, bandwidth (BW), a number of spatial streams (NSS), a modulation and coding scheme (MCS), or a link information.

In some examples, the default power save mode information is received, by the AP, through one of a management frame, an action frame, a control frame, or a beacon frame.

In some examples, the updated power save mode information includes the type of power save mode. In some examples, the updated power save mode information further includes the features of the power save mode.

In some examples, the updated power save mode information is received, by the AP, through one of a management frame, an action frame, a control frame, or a beacon frame.

In some examples, the updated power save mode information is received, by the AP, through the initial control frame.

One aspect of the present disclosure provides a computer-implemented method for wireless communication by an access point (AP) in a wireless network. The method comprises receiving a default power save mode information from the STA. The method comprises receiving an updated power save mode information that includes at least one associated configurable parameter associated with power save to a peer STA.

In some examples, the default power save mode information comprises at least one of: a type of power save mode, a power save mode feature, operational parameters, bandwidth (BW), a number of spatial streams (NSS), a modulation and coding scheme (MCS), or a link information.

In some examples, the default power save mode information is received, by the AP, through one of a management frame, an action frame, a control frame, or a beacon frame.

In some examples, the updated power save mode information includes the type of power save mode. In some examples, the updated power save mode information further includes the features of the power save mode.

In some examples, the updated power save mode information is received, by the AP, through one of a management frame, an action frame, a control frame, or a beacon frame.

In some examples, the updated power save mode information is received, by the AP, through the initial control frame.

One aspect of the present disclosure provides a non-transitory computer-readable storage medium. The methods disclosed herein can be performed by one or more computer programs stored on the non-transitory computer-readable storage medium.

In some examples, the non-transitory computer-readable storage medium stores one or more computer programs, when executed by at least one processor individually or collectively, cause a STA to determine a need to indicate a power save mode including at least one of enablement or update based on at least one of a status of the STA or a user input. The one or more computer programs, when executed by at least one processor individually or collectively, further cause the STA to transmit, by the STA, an updated power save mode information that includes at least one associated configurable parameter associated with power save to a peer STA based on the determination.

In some examples, the non-transitory computer-readable storage medium stores one or more computer programs, when executed by at least one processor individually or collectively, cause an AP to receive a default power save mode information from a STA. The one or more computer programs, when executed by the at least one processor individually or collectively, cause the AP to receive an updated power save mode information that includes at least one associated configurable parameter associated with power save to a peer STAa.

At least one processor 402 individually or collectively executes instructions to cause a device (e.g., a STA 400, a non-STA AP) to perform the operations disclosed herein. At least one power saving controller 406 individually or collectively executes instructions to cause a device (e.g., a STA 400, a non-STA AP) to perform the operations disclosed herein. At least one processor 402 and at least one power saving controller 406 collectively execute instructions to cause a device (e.g., a STA 400, a non-STA AP) to perform the operations disclosed herein.

The embodiments disclosed herein can be implemented through at least one software program running on at least one hardware device and performing network management functions to control the network elements. The elements include blocks which can be at least one of a hardware device, or a combination of hardware device or software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed:

1. A station (STA) in a wireless network, the STA comprising:
at least one processor including processing circuitry; and
memory storing instructions that, when executed by the at least one processor individually or collectively, cause the STA to:
determine a need to inform a first device of update of a power save mode of the STA based on at least one of a status of the STA or a user input; and
transmit information on an updated power save mode to the first device, the information including at least one configurable parameter associated with the power save mode.

2. The STA of claim 1, wherein the information on the updated power save mode is transmitted to the first device irrespective of data activity.

3. The STA of claim 1, wherein the instructions, when executed by the at least one processor individually or collectively, further cause the STA to:
determine a default power save mode for the STA, when the STA powers up
transmit information on a default power save mode and at least one configurable operating mode capability to the first device, based on the default power save mode; and
control power saving based on the default power save mode.

4. The STA of claim 1, wherein the information on the updated power save mode is transmitted to the first device based on at least one frame format, the at least one frame format comprising at least one of: a management frame format, an action frame format, a control frame format, or a beacon frame format to indicate at least one enablement or update of operational parameters for the associated power save mode and feature.

5. The STA of claim 4, wherein the at least one frame format indicates a power saving feature or the power save mode.

6. The STA of claim 4, wherein the at least one frame format indicates at least one of a power saving feature, a power save mode, operational parameters: bandwidth (BW), a number of spatial streams (NSS), a modulation and coding scheme (MCS), or link information for at least one enablement or update of power save mode.

7. The STA of claim 3, wherein the instructions, when executed by the at least one processor individually or collectively, further cause the STA to:
transmit the information on the default power save mode via at least one of: a beacon frame, a re-association request frame, a re-association response frame, a probe request frame or a probe response frame.

8. The STA of claim 3, wherein the default power save mode information comprises at least one of: a type of power save mode, a power save mode feature, operational parameters, bandwidth (BW), a number of spatial streams (NSS), a modulation and coding scheme (MCS), or a link information.

9. The STA of claim 1, wherein the instructions, when executed by the at least one processor individually or collectively, further cause the STA to:
transmit an indication of a power saving category to the first device.

10. The STA of claim 9, wherein the transmitting the indication of the power saving category comprises:
configuring a power saving category included in different power save features and different power save modes;
transmitting an indication of a default power save category based on determining the default power save mode of operation;
determining a need to transmit the power saving category to the first device when at least one of: the STA powers up or the power saving category changes; and
transmitting the modified power saving category to the first device.

11. The STA of claim 10, wherein a mapping table is utilized for at least one of: at least one single-link operation or at least one multi-link operation in the power saving category.

12. The STA of claim 10, wherein the power saving category is indicated using a frame structure, wherein the power saving category includes at least one of a bandwidth (BW), a number of spatial streams (NSS), a modulation and coding scheme (MCS), or link information.

13. The STA of claim 12, wherein the frame structure indicates the power saving category associated with at least one of a power saving feature or a power save mode of an operation.

14. The STA of claim 10, wherein the default power save category is indicated in a capability information element of the STA.

15. The STA of claim 10, wherein the power saving category is associated with a power saving feature and a mode of an operation is indicated in a power saving capability information element of the STA.

16. The STA of claim 9, wherein the instructions, when executed by the at least one processor individually or collectively, further cause the STA to:
determine whether a dynamic power save mode is supported; and
set a power saving category associated with a low power and high-power mode in response to determining that the dynamic power save mode is supported.

17. The STA of claim 9, wherein the instructions, when executed by the at least one processor individually or collectively, further cause the STA to:
determine whether a scheduled power save mode is supported; and
sett the power saving category to be associated with at least one of: a low capability mode or a high capability mode in response to determining that the scheduled power save mode is supported.

18. The STA of claim 9, wherein the instructions, when executed by the at least one processor individually or collectively, further cause the STA to:
determine whether a cross-link power management mode is supported; and
set a power saving category associated with each link in response to determining that the cross-link power management mode is supported.

19. The STA of claim 1, wherein the instructions, when executed by the at least one processor individually or collectively, further cause the STA to:
determine whether the first device remains in at least one of a high capability mode or a low capability mode; and
transmit an indication in an Initial Control Frame (ICF) to indicate to the peer STA that, upon receiving a notification, the first device shall remain in at least one of the high capability mode or the low capability mode.

20. A computer-implemented method for wireless communication by a station (STA) in a wireless network, the method comprising:
determining, by a station (STA), a need to indicate a power save mode including at least one of enablement or update based on at least one of a status of the STA or a user input; and
transmitting, by the STA, an updated power save mode information that includes at least one associated configurable parameter associated with power save to a first device based on the determination.
